(19) United States
(12) Patent Application Publication
(10) Pub. No.: US 2015/0174688 A1
(43) Pub. Date: Jun. 25, 2015

(54) SPOT WELDING METHOD FOR HIGH STRENGTH STEEL SHEET

(71) Applicants: Hyundai Motor Company, Seoul (KR); Dong-eui University Industry-Academic Cooperation Foundation, Busan (KR)

(72) Inventors: Ji Hong Yoo, Seoul (KR); Seung Hyun Hong, Seoul (KR); Yeong Do Park, Busan (KR); Jae Won Kim, Gumi, Gyeongsangbuk-do (KR)

(21) Appl. No.: 14/451,759

(22) Filed: Aug. 5, 2014

(30) Foreign Application Priority Data
Dec. 20, 2013 (KR) 10-2013-0160773

(51) Int. Cl. B23K 11/11; B23K 11/16; B23K 11/24

(52) U.S. Cl. CPC B23K 11/11; B23K 11/241; B23K 11/166

(57) ABSTRACT

A spot welding method for a high strength steel sheet is provided. The method includes a first pulse step for applying electric current of about 8 to 9 kA about 1 to 3 cy and a first cooling step for cooling for about 1 to 3 cy. In addition, the method includes a second pulse step for applying electric current less than the electric current applied in the first pulse step and a second cooling step for cooling for about 1 to 3 cy. A third pulse step includes applying electric current greater than the electric current applied in the second pulse step.

### CROSS-REFERENCE(S) TO RELATED APPLICATION

The present application claims priority of Korean Patent Application Number 10-2013-0160773 filed on Dec. 20, 2013, the entire contents of which application is incorporated herein for all purposes by this reference.

### TECHNICAL FIELD

The present invention relates to a spot welding method for a high strength steel sheet having a maximal Nugget diameter using multiple-pulse welding conditions.

### BACKGROUND

Recently, with the increased use of high strength steel sheets in industrial sites, maintaining a Nugget diameter in a resistance spot welding of ultrahigh strength galvanized steel sheets, for example, 120 kgf level galvanized steel sheets has been a recognized difficulty. During a single pulse welding, spatters are generated due to an excellent heat generating property of a steel material, thereby causing difficulties in obtaining a sufficient Nugget diameter. Meanwhile, when using a conventional multiple-pulse welding, many welding variables are applied, but may not be appropriate for the industrial sites. Therefore, selecting appropriate welding conditions may be more complex.

When the conventional technology uses three types of pulses, roles of each pulse and relevance therebetween have not been suggested clearly. Moreover, due to extended welding time, it is difficult to apply such techniques to the industrial site because of low productivity. Furthermore, when a cooling time exists between pulses, guidelines are provided only about welding temperature but about welding time, so there have been a lot of problems when the guidelines of the conventional technologies are applied in actual practice. The description provided above as a related art of the present invention is just for helping understanding the background of the present invention and should not be construed as being included in the related art known by those skilled in the art.

### SUMMARY

The present invention provides technical solutions to the above mentioned technical difficulties in the art. One exemplary embodiment of the present invention provides a spot welding method for a high strength steel sheet having a maximal Nugget diameter using a multiple-pulse welding conditions.

In particular, in the exemplary embodiment of the present invention, a spot welding method for a high strength steel sheet may include: a first pulse step for applying electric current of about 8 to 9 kA for 1 to 3 cy; a first cooling step for cooling for 1 to 3 cy; a second pulse step for applying electric current less than the electric current applied in the first pulse step; a second cooling step for cooling for 1 to 3 cy; and a third pulse step for applying electric current greater than the electric current applied in the second pulse step.

In the first pulse step, the electric current may be applied for 2 cy. In the first cooling step, the cooling may be performed for 2 cy. In the second pulse step, the electric current of about 70 to 80% of the electric current applied in the first pulse step may be applied. In addition, in the second pulse step, the electric current may be applied for 4 to 10 cy. In the second cooling step, the cooling may be performed for 2 cy. In the third pulse step, the electric current of about 7 to 9 kA may be applied. In the third pulse step, the electric current may be applied for 10 cy or more. In addition, in the third pulse step, the electric current may be applied for 10 cy or more just prior to generating a spatter.

In another exemplary embodiment, a spot welding method for a high strength steel sheet may include: a first pulse step for applying electric current of about 8 to 9 kA for 1 to 3 cy; a first cooling step for cooling for 1 to 3 cy; a second pulse step for applying electric current of about 70 to 80% of the electric current applied in the first pulse step for a time longer than that in the first pulse step; a second cooling step for cooling for 1 to 3 cy; and a third pulse step for applying electric current greater than the electric current applied in the second pulse step.

In yet another exemplary embodiment, a spot welding method for a high strength steel sheet may include: a first pulse step for applying electric current of about 8 to 9 kA for 1 to 3 cy; a first cooling step for cooling for 1 to 3 cy; a second pulse step for applying electric current less than the electric current applied in the first pulse step; a second cooling step for cooling for 1 to 3 cy; and a third pulse step for applying electric current greater than the electric current applied in the second pulse step and smaller than the electric current applied in the first pulse step for a time longer than that in the second pulse step.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 shows an exemplary diagram of spot welding method for a high strength steel sheet in respect of time and electric current applied in each electric pulse step and each cooling step according to an exemplary embodiment of the present invention.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, a spot welding method for a high strength steel sheet according to the present invention will be explained in detail referring to drawings.

The spot welding method for a high strength steel sheet according to one exemplary embodiment of the present invention may include: a first pulse step 10 for applying electric current of about 8 to 9 kA for 1 to 3 cy; a first cooling step 20 for cooling for 1 to 3 cy; a second pulse step 30 for applying electric current smaller than the electric current applied in the first pulse step 10; a second cooling step 40 for cooling for 1 to 3 cy; and a third pulse step 50 for applying electric current greater than the electric current applied in the second pulse step 30.

In the first pulse step 10, the electric current may be applied for 2 cy. In the first cooling step 20, the cooling may be performed for 2 cy. In the second pulse step 30, electric current of about 70 to 80% of the electric current applied in the first pulse step may be applied. In addition, in the second pulse step 30, the electric current may be applied for 4 to 10 cy. In the second cooling step 40, the cooling may be performed for 2 cy. In the third pulse step 50, electric current of about 7 to 9 kA may be applied. In addition, in the third pulse step 50, the electric current may be applied for 10 cy or more. In the third pulse step 50, the electric current may be applied for 10 cy or more prior to generating a spatter.

In another exemplary embodiment, the spot welding method for a high strength steel sheet may include: a first pulse step 10 for applying electric current of about 8 to 9 kA for 1 to 3 cy; a first cooling step 20 for cooling for 1 to 3 cy; a second pulse step 30 for applying electric current of about 70 to 80% of the electric current applied in the first pulse step 10 for a time longer than that in the first pulse step 10; a second cooling step 40 for cooling for 1 to 3 cy; and a third pulse step 50 for applying electric current greater than the electric current applied in the second pulse step 30.

In yet another exemplary embodiment, the spot welding method for a high strength steel sheet may include: a first pulse step 10 for applying electric current of about 8 to 9 kA for 1 to 3 cy; a first cooling step 20 for cooling for 1 to 3 cy; a second pulse step 30 for applying electric current smaller than the electric current applied in the first pulse step 10; a second cooling step 40 for cooling for 1 to 3 cy; and a third pulse step 50 for applying electric current greater than the electric current applied in the first pulse step 10 and smaller than the electric current applied in the second pulse step 30 for a time longer less that in the second pulse step 30.

The exemplary embodiment of the present invention relates to a technology that may maintain a maximal Nugget diameter by optimizing welding conditions appropriate for obtaining such properties of ultrahigh strength steel material, for example, about 100 kgf level or greater including 120 kgf level material, in consideration of mechanisms such as generation, growth and behavior of the Nugget which may be generated in resistance spot welding of high strength steel material. Meanwhile, time unit, cy, used in the present invention may be about 1/60 second, which is an unit cycle of time.

Multiple pulses may be required in resistance welding, and each pulse may have an individual function and role for improving high strength property. The first pulse may maximize contact area between boards. Such a maximization may increase a current path (e.g., conducting area) for the welding current conducted in the next pulse. The second pulse may generate a corona bond for minimizing separation between boards caused by suppressing a spatter and generating a melting part. The corona bond may be generated at the same time when the Nugget diameter is generated.

The third pulse may play a role in growing the Nugget diameter to a maximum. The maximal Nugget diameter may be obtained through welding current until a spatter is generated. Moreover, the available welding current section may be extended as well. Such welding conditions may include variables of pressurizing force and welding time which may be applied in the industrial site. When the welding condition for each pulse is properly selected, the maximal Nugget diameter may be obtained by resistance spot welding on various types of high strength steel sheets.

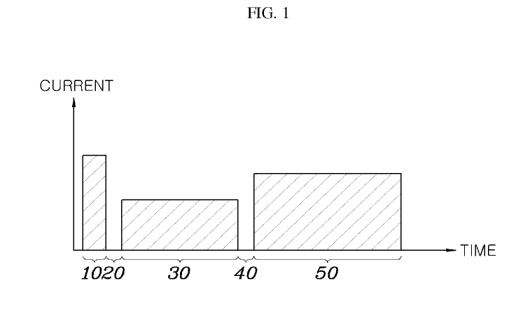

FIG. 1 shows an exemplary diagram of spot welding method for a high strength steel sheet in respect to time and electric current applied in each step according to one exemplary embodiment of the present invention. The electric current of about 8 to 9 kA may be applied for 1 to 3 cy in the first pulse step 10. This step 10 may maximize contact area between boards, and it is important to prevent the Nugget diameter from being generated. Thus, this step 10 may increase the contact area between boards without Nugget generation at high current for a substantially short period of time, and increase contact area between an electrode and a board and between boards in a substantially short period of time by using an excellent heat generating property of high alloy high strength steel.

Further in detail, the welding electric current, i.e. 8 to 9 kA, and the welding time in the first pulse step that may increase contact area between an electrode and a board and between boards may be selected. For optimizing the conditions, it may be performed before generating melting or Nugget diameter, and in such condition, the width of current conduction may be equalized. When high current is applied during a substantially short period of time, a maximal contact area may be obtained between boards before generating the Nugget diameter. Accordingly, the welding time of the first pulse may be between about 1 to 3 cy before generating Nugget.

According to exemplary experimental results, when the electric current in the first pulse step 10 is about 9 kA or greater, the Nugget may be abruptly grown in about 2 cy. Additionally, when the first pulse step is performed for about 3 cy or greater, the Nugget may be abruptly grown even at about 8 kA of electric current. Meanwhile, when higher electric current (e.g., about 10 kA or greater) is applied for longer period of time (e.g., about 4 cy or more), spatters may be generated. Accordingly, in the first pulse step 10, electric current of about 8 to 9 kA for about 1 to 3 cy may be applied.

Meanwhile, in the first cooling step 20, the cooling is performed for about 1 to 3 cy. This cooling step 20 mainly aims to restrain heat generation; therefore the amount of heat input may be controlled. Spatter generation may be inhibited by adjusting the amount of heat input during the cooling time and causing generation of a corona bond or due to difference in the range thereof, thereby controlling size of the Nugget diameter.

Specifically, when a cooling step 20 is performed between the first pulse and the second pulse, the amount of heat input may be controlled. When the cooling time exists, heat generation may be restricted and growth of the Nugget diameter may be restrained. However, the cooling time may not affect the corona band significantly. Further, the cooling time may be about 2 cy. When the cooling time is prolonged to about 4 cy or greater, the Nugget diameter may be decreased in the third pulse. With the same reason, in the second cooling step 40, the cooling time may be about 2 cy.

When the first pulse is applied at about 8 kA for 2 cy, the second pulse may be applied at about 6 kA for about 6 cy, the third pulse may be applied at about 7 kA for about 12 cy, and the second cooling time may be set as about 2 cy, a test was executed by varying the first cooling time only. According to the test results, when the first cooling time was 0 cy, 2 cy and 4 cy, respectively, the Nugget diameter was reduced consequently to 5.95 mm, 5.88 mm and 5.53 mm after applying the third pulse. Accordingly, for minimal cooling, the cooling time may be about 2 cy.

In the second pulse step 30, electric current may be of about 70% to 80% of the electric current applied in the first pulse step 10 for about 4 to 10 cy. This step 30 aims mainly to grow the corona bond while minimizing the Nugget diameter. Additionally, to prevent spatters from being generated, the corona bond may be generated; and to minimize a notch part by board division, the Nugget diameter may be minimized. Specifically, in the second pulse step 30, the electric current corresponding to about 70% to 80% of the electric current in the first pulse may be applied, because the electric current of 100% or greater of the first electric current may generate spatters.

When the time of the second pulse is prolonged, the Nugget diameter may be grown without varying the corona bond, and when the Nugget diameter is increased, the notch may be generated by board division at both ends of a melting part, thereby acting as an inhibiting factor against increasing the current path (e.g., conducing area). Thus, considering a condition for generating a minimal Nugget diameter, the welding time of the second pulse step 30 may be about 4 to 10 cy.

According to other test results, when the electric current in second pulse did not exceed 50% of the welding current of the first pulse, the corona bond was not generated. In this case, the Nugget diameter was not generated although the welding time was prolonged. From those results, the Nugget diameter is not generated even when the first electric current pulse is applied at about 8 kA for about 3 cy; the first cooling time 20 is about 2 cy; the second electric current pulse is fixed at about 4 kA; and application time of the second pulse 30 is prolonged or even up to about 10 cy.

In the second cooling step 40, the cooling time may be same as in the first cooling step 20. This second cooling may restrain heat generation, thereby inhibiting generation of a spatter and extending the range of current available in the third pulse step 50 by controlling input heat according to the cooling time. In the third pulse step 50, about 7 to 9 kA of electric current may be applied, the pulse time may be 10 cy or greater, and the electric current may be applied until a spatter is generated. This step 50 may maintain the maximal Nugget diameter prior to generating spatters, therefore the maximal Nugget diameter may be obtained with a high welding current and a substantially long welding time. Accordingly, the maximal Nugget diameter may be obtained by each combination of plate material.

Furthermore, the third pulse may have a current value greater than the electric current value applied in the second pulse. The third pulse may have a welding current section from the second cooling and prior to a spatter. Prolongation of the welding time of the third pulse may have an effect of increasing the Nugget diameter. Accordingly, the welding time of the third pulse may be about 10 cy, whereas the maximum welding time may be up to an industrial site condition or a spatter generating condition. Through this third pulse step 50, the size of a maximal Nugget diameter may be increased by about 20% or more compared to a single pulse condition.

When varying the welding time by 12 cy, 14 cy, 16 cy, 18 cy, and 20 cy at 8.6 kA of electric current in single pulse, each of the Nugget diameters was measured as 6.11 mm, 5.81 mm, 5.79 mm, 5.81 mm and 5.97 mm, respectively. From these results, the Nugget diameter may be about 6.11 mm from a single pulse. When the welding time is increased, the welding current decreased prior to a spatter, thereby showing no change in the Nugget diameter.

According to the spot welding method for the high strength steel sheet having a structure described hereto, a maximal Nugget diameter may be obtained using pulse welding conditions.

Although the present invention was described with reference to exemplary embodiments shown in the drawings, it is apparent to those skilled in the art that the present invention may be changed and modified in various ways without departing from the scope of the present invention, which is described in the following claims.

What is claimed is:

1. A spot welding method for a high strength steel sheet comprising:
a first pulse step for applying electric current of about 8 to 9 kA for about 1 to 3 cy;
a first cooling step for cooling for about 1 to 3 cy;
a second pulse step for applying electric current less than the electric current applied in the first pulse step;
a second cooling step for cooling for about 1 to 3 cy; and
a third pulse step for applying electric current greater than the electric current applied in the second pulse step.

2. The spot welding method for the high strength steel sheet of claim 1, wherein in the first pulse step, the electric current is applied for about 2 cy.

3. The spot welding method for the high strength steel sheet of claim 1, wherein in the first cooling step, the cooling is performed for about 2 cy.

4. The spot welding method for the high strength steel sheet of claim 1, wherein in the second pulse step, the electric current of about 70 to 80% of the electric current applied in the first pulse step is applied.

5. The spot welding method for the high strength steel sheet of in claim 1, wherein in the second pulse step, the electric current is applied for about 4 to 10 cy.

6. The spot welding method for the high strength steel sheet of in claim 1, wherein in the second cooling step, the cooling is performed for about 2 cy.

7. The spot welding method for the high strength steel sheet of in claim 1, wherein in the third pulse step, the electric current of about 7 to 9 kA is applied.

8. The spot welding method for the high strength steel sheet of claim 1, wherein in the third pulse step, the electric current is applied for about 10 cy or more.

9. The spot welding method for the high strength steel sheet of claim 1, wherein in the third pulse step, the electric current is applied for about 10 cy or more prior to generation of a spatter.

10. A spot welding method for a high strength steel sheet comprising:
a first pulse step for applying electric current of about 8 to 9 kA for about 1 to 3 cy;
a first cooling step for cooling for about 1 to 3 cy;
a second pulse step for applying electric current of about 70 to 80% of the electric current applied in the first pulse step for a time greater than that in the first pulse step;
a second cooling step for cooling for about 1 to 3 cy; and
a third pulse step for applying electric current greater than the electric current applied in the second pulse step.

11. A spot welding method for a high strength steel sheet comprising:
a first pulse step for applying electric current of about 8 to 9 kA for about 1 to 3 cy;
a first cooling step for cooling for about 1 to 3 cy;
a second pulse step for applying electric current less than the electric current applied in the first pulse step;
a second cooling step for cooling for about 1 to 3 cy; and
a third pulse step for applying electric current greater than the electric current applied in the second pulse step and less than the electric current applied in the first pulse step for a time greater than that in the second pulse step.
